(19) United States
(12) Patent Application Publication
(10) Pub. No.: US 2026/0024099 A1
(43) Pub. Date: Jan. 22, 2026

(54) AUTHENTICATABLE ENCLOSURE FOR AN ELECTRONIC DEVICE

(71) Applicant: Sandisk Technologies, Inc., Milpitas, CA (US)

(72) Inventor: Daniel Bedau, San Jose, CA (US)

(21) Appl. No.: 18/774,511

(22) Filed: Jul. 16, 2024

(51) Int. Cl. G06Q 30/018; G06F 21/86

(52) U.S. Cl. CPC G06Q 30/0185; G06F 21/86

(57) ABSTRACT

An electronic device includes an enclosure that is formed using a first material and a second material. The first material has a first physical property and the second material has a second physical property that is different from the first physical property. When the first material and the second material are combined, the difference between the physical properties of each material causes a unique pattern to be formed on and/or in the enclosure. The unique pattern is usable to verify the authenticity of the electronic device.

### BACKGROUND

Electronic components and devices are increasingly susceptible to counterfeiting and counterfeit manufacturing. That is, a growing number of consumers are unintentionally purchasing and/or using counterfeit electronic components and devices despite holding the belief that the electronic components and devices are genuine.

As demand for electronic components and devices increases, the number of counterfeit components and devices on the consumer market is also increasing. Unfortunately, it is difficult for consumers to determine whether an electronic component or device is legitimate and/or consumers are unaware of how to determine whether electronic components and devices are legitimate. If a consumer unknowingly purchases a counterfeit product, many negative outcomes may arise for the consumer and/or for manufacturers of the legitimate electronic components and device. These negative outcomes may include, but are not limited to, poor customer satisfaction, data security and data integrity issues, poor product performance and efficiency and/or reduced product safety.

Accordingly, it would be beneficial for electronic components and devices to have authentication features that enable consumers and manufacturers to quickly and easily verify the authenticity of electronic components and devices.

### SUMMARY

The present disclosure describes an enclosure for an electronic device that protects the electronic device from being counterfeited and/or enables the authenticity of the electronic device to be easily verifiable. In an example, the enclosure is made from a first material and a second material. Each material has a particular property that causes a unique pattern to be embedded on and/or in the enclosure when the enclosure is formed. In an example, the unique pattern is usable to verify the authenticity of the electronic device.

In one example, the first material and the second material are the same material (e.g., an epoxy resin). However, the first material has a first property and the second material has a second property that causes the first material to be distinguishable from the second material. For example, the first material has a first color (e.g., black) and the second material has a second color (e.g., white). In another example, the first material has a first density and the second material has a second density. In yet another example, the first material has a first absorption property and the second material has a second absorption property. In yet other examples, the first material is an epoxy resin and the second material is a particulate or some other material that may be injected into and/or on the epoxy resin.

During a molding process (e.g., a single shot injection molding process, a multi-shot injection molding process, a transfer molding process), the first material and/or the second material are injected into a mold. As the first material and the second material are injected into the mold, the first material and the second material, along with their associated properties, cause a random and unique pattern to form on the surface of the enclosure and/or otherwise be embedded in the enclosure.

The random pattern is imaged and a verification template is calculated. The verification template reflects the pattern of the enclosure and is subsequently usable to verify the authenticity of the electronic device.

Accordingly, examples of the present disclosure describe an enclosure for an electronic device. In an example, the enclosure includes a first material having a first property and a second material having a second property that is different from the first property. A random pattern for the enclosure is created during the formation of the enclosure by combining the first material having the first property and the second material having the second property.

Other examples describe an enclosure for an electronic device. An embedded pattern is provided on a surface of the enclosure. In an example, the embedded pattern is formed during formation of the enclosure and is used to verify the authenticity of the electronic device.

The present disclosure also describes an electronic device having an enclosing means surrounding at least one electronic component of the electronic device. In an example, the enclosing means includes an embedded random pattern. The embedded random pattern is created by combining a first material having a first property and a second material having a second property during the formation of the enclosing means.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1A illustrates an electronic device having an enclosure according to a first example.

FIG. 1B illustrates an electronic device having an enclosure according to a second example.

FIG. 2A illustrates an electronic device having an enclosure with a pattern embedded on a surface according to an example.

FIG. 2B illustrates an electronic device having an enclosure with a pattern embedded on a surface according to another example.

FIG. 3 illustrates an electronic device having an enclosure with a pattern embedded on a surface according to yet another example.

FIG. 4 illustrates an electronic device having an enclosure with a pattern and a computer-readable code on a surface according to an example.

FIG. 5 illustrates an example verification database that is used to authenticate an electronic device according to an example.

FIG. 6 illustrates an electronic device having an enclosure with an embedded pattern according to another example.

FIG. 7 illustrates an electronic device having an enclosure with an embedded pattern according to yet another example.

FIG. 8 illustrates an electronic device having an enclosure with an embedded pattern according to yet another example.

FIG. 9 illustrates a method for forming an enclosure with an embedded pattern for an electronic device according to an example.

FIG. 10 illustrates a method for verifying the authenticity of an electronic device based, at least in part, on a pattern embedded within the enclosure of the electronic device according to an example.

FIG. 11 is a system diagram of a computing device according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. The following detailed description is therefore not to be taken in a limiting sense, and the scope of the present disclosure is defined by the appended claims and their equivalents.

Demand for electronic devices continues to increase in a growingly-digital world. As a result, the prevalence of counterfeit electronic devices on the consumer market is also increasing. Counterfeit electronic devices refer to any type of electronic component or electronic device that is, for example, re-topped and/or re-marked to disguise parts differing from those offered by the original manufacturer. Additionally, counterfeit electronic devices refer to electronic components or electronic devices that include defective parts scrapped by the original part manufacturer or previously used parts salvaged from scrapped assembly. Counterfeit electronic devices may also refer to electronic components or electronic devices which have been refurbished, but are represented and sold to consumers as a new product. This poses a threat to manufacturer integrity, product safety, data security and retention and product efficiency.

Standard methods of authenticating electronic devices rely on a foundation of knowledge by the consumer to distinguish minute details between genuine electronic devices and counterfeits. However, most consumers lack the knowledge or have the expertise to be able to determine whether an electronic device is authentic or counterfeit.

To address the above, an enclosure for an electronic device is described. The enclosure lends itself to easy verification by the consumer to enable the consumer to determine whether the component is counterfeit or genuine. For example, the enclosure is manufactured using materials of differing physical properties. During the formation of the enclosure, the materials are randomly used (e.g., injected into a mold) to create an enclosure that cannot be replicated.

In an example, the enclosure is made from a first material and a second material. Each material has a particular property that causes the enclosure to have an embedded unique pattern when formed. The unique pattern is usable to verify the authenticity of the electronic device.

For example, the first and second materials is a resin. However, the first material has a first property and the second material has a second property that causes the first material to be distinguishable from the second material. For example, the first material has a first color (e.g., black) and the second material has a second color (e.g., white). In another example, the first material has a first density and the second material has a second density. In yet another example, the first material has a first absorption property and the second material has a second absorption property. In other examples, the first material is a resin and the second material is a different material (e.g., a particulate or a resin that includes particulates).

During a molding process in which the enclosure is formed, the first material and the second material are injected into a mold. The unique properties of each material causes a random and unique pattern to form on a surface of the enclosure.

The random pattern is imaged and a verification template is calculated that reflects the pattern of the enclosure. The verification template is cryptographically signed and etched onto the enclosure. To verify the authenticity of the electronic device, a consumer scans the computer-readable code (e.g., using a camera of a mobile phone) and accesses a database to verify the authenticity of the electronic device (e.g., using a cryptographic keyword pair and/or by visually comparing the pattern on the enclosure with the imaged copy of the enclosure stored in the database).

In accordance with the above, many technical benefits may be realized including, but not limited to, enabling an authenticity of an electronic device to be easily and quickly verified without increasing the cost of electronic device manufacturing in terms of time and/or money and increasing the security of electronic devices without the need for additional components.

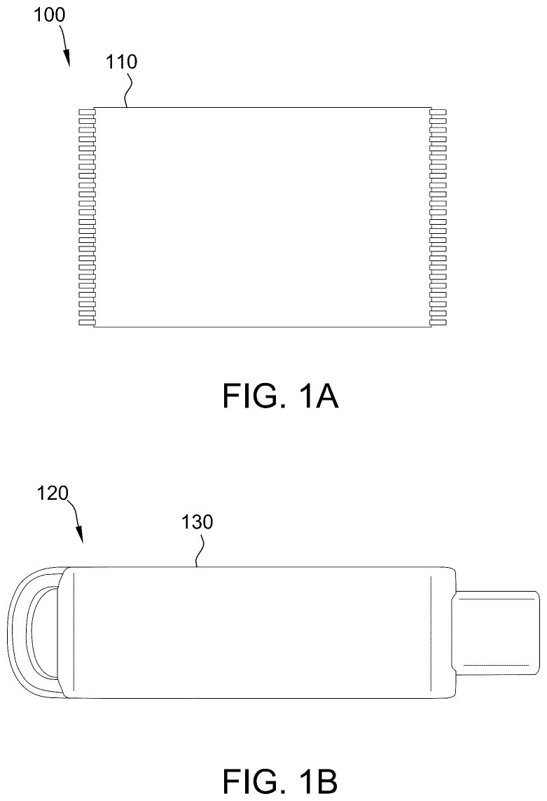

These and other examples will be explained in greater detail below with respect to FIG. 1A-FIG. 11.

FIG. 1A illustrates an electronic device 100 having an enclosure 110 according to a first example. In this example, the electronic device 100 is a semiconductor package (e.g., a NAND memory package) and the enclosure 110 is formed by a molding compound. However, in this example, there is no way for a consumer to readily identify whether this particular electronic device 100 is authentic or counterfeit.

FIG. 1B illustrates an electronic device 120 having an enclosure 130 according to a second example. In this example, the electronic device 120 is a removable data storage device. The electronic device 120 includes an enclosure 130 or a housing that surrounds and protects the various electronic components of the electronic device 120. However, like the example shown and described with respect to FIG. 1A, there is no way for a consumer to readily identify whether this particular electronic device 120 is authentic or counterfeit.

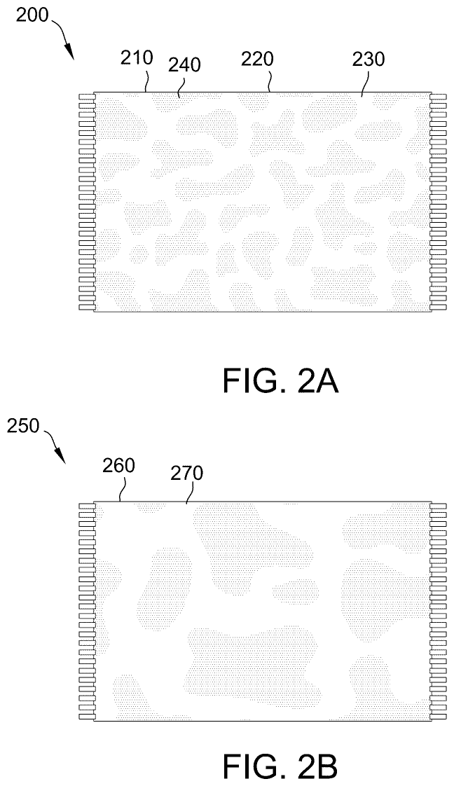

FIG. 2A illustrates an electronic device 200 having an enclosure 210 with a pattern 220 embedded on a surface according to an example. In this example, the electronic device 200 is semiconductor package such as, for example, a NAND memory package. Although a semiconductor package is specifically shown and described, the electronic device 200, and the associated enclosure 210, may be any type of electronic component and/or electronic device.

In an example, the enclosure 210 is formed or created using a molding process. For example, the enclosure 210 is formed by an injection molding process (e.g., a single shot injection molding process, a multi-shot injection molding process) a transfer molding process, a compression molding process or any other type of process in which an enclosure or a housing is formed on or over a substrate and/or various electronic components (e.g. semiconductor dies, capacitors, resistors) that are coupled to a surface of the substrate.

However, to enable the electronic device 200 to be readily and easily authenticatable, a first material 230 and a second material 240 are used to form the enclosure 210. In some examples, the first material 230 and the second material 240 are the same material (e.g., a molding compound, an epoxy resin). In another example, the first material 230 and the second material 240 are different materials. For example, the first material 230 is an epoxy resin and the second material 240 is a particulate (e.g., flakes of materials such as glitter, synthesized opal, acrylics or other materials, a magnetic material), a polymer, or various other fillers or materials having various atomic weights. However, regardless of whether the first material 230 and the second material 240 are the same material, each material has a different property (e.g., a different physical property).

In one example, the physical property is a pigment, a dye, or a color. In another example, the physical property is whether the physical property is visible to the naked-eye. For example, the physical property of at least one of the materials is a luminescence, a fluorescence, a color, pigment and/or a dye that cause at least a portion of the pattern 220 to only be visible when using an ultraviolet (UV) light and/or an infrared light. In another example, the physical property is an absorption of the first material and/or the second material that is used to form the enclosure 210. In yet another example, the physical property is a density of the first material and/or the second material that is used to form the enclosure 210.

The physical properties associated with the first material 230 and the second material 240 cause the pattern 220 to be formed on the enclosure 210. In an example, the pattern 220 is completely random and cannot be duplicated or replicated. For example, during the molding process (or another process in which the enclosure 210 is formed), the first material 230 is provided in a first injector of a molding machine and subsequently inserted into a mold at a first time. Likewise, the second material 240 is inserted into a second injector of the molding machine and subsequently inserted into the mold at a second time. As each material is inserted into the mold, the pattern 220 is formed/created.

To further increase the randomness of the pattern 220, the timing and/or the frequency with which the first injector and/or the second injector are used may also be randomized. For example, during the molding process, a computing device that controls the molding machine may randomly switch between the first injector and the second injector.

In another example, the first material 230 and the second material 240 are injected into the mold at the same time. In yet another example, the first material 230 and the second material 240 are injected into the mold in a same direction or in a similar direction. In another example, the first material 230 and the second material 240 are injected into the mold in opposite directions (e.g., at different sides or ends of the mold) thereby introducing sheer flow which causes a random pattern to form.

In an example, the timing of each injection can be varied or random. In yet another example, the first material 230 is injected into the mold at a first random time (or times) and the second material 240 is injected into the mold at a second random time (or times).

Varying the timing of injection, the duration of each injection and/or a sequence of the injections further randomizes the pattern 220 on the surface of the enclosure 210. For example, and referring to FIG. 2B, FIG. 2B illustrates an electronic device 250 having an enclosure 260 with a pattern 270 embedded on a surface according to another example. In this example, the electronic device 250 is similar to the electronic device 200 shown and described with respect to FIG. 2A.

However, the pattern 270 on the enclosure 260 of the electronic device 250 is different from, and unique when compared to, the pattern 220 on the enclosure 210 of the electronic device 200. In an example, the difference between the pattern 220 of FIG. 2A and the pattern 270 of FIG. 2B is a result of injection molding timing differences between when each enclosure was formed. In another example, the difference in the patterns is the result of different physical properties of the materials that were used to form each enclosure. Although specific examples are given, the difference between the patterns is a natural result of the randomness that occurs when two materials are injected into a mold to form an enclosure.

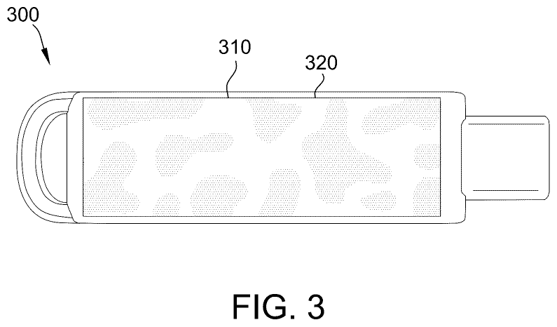

FIG. 3 illustrates an electronic device 300 having an enclosure 310 with a pattern 320 embedded on a surface according to yet another example. In an example, the electronic device 300 is similar to the electronic device 120 shown and described with respect to FIG. 1B. For example, the electronic device 300 is a removable data storage device and the enclosure 310 is a housing. Although a removable data storage device is shown and described, the electronic device 300 may be any type of electronic device that includes a housing or an enclosure.

Unlike the electronic device 120 shown and described with respect to FIG. 1B, the enclosure 310 of the electronic device 300 includes a pattern 320. Like the examples previously shown and described, the pattern 320 is embedded on and/or in the enclosure 310 when the enclosure is being formed. Additionally, the pattern 320 may be used to verify the authenticity of the electronic device 300 such as will be described in greater detail herein.

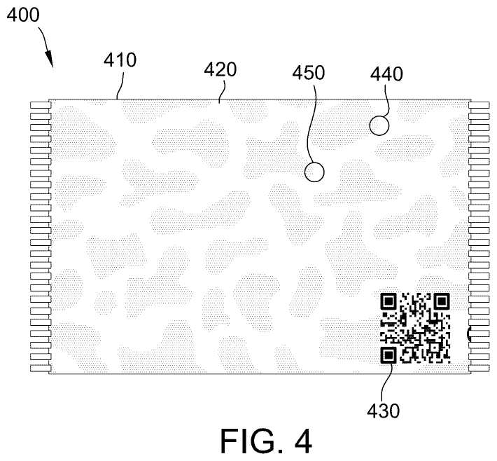

FIG. 4 illustrates an electronic device 400 having an enclosure 410 with a pattern 420 and a computer-readable code 430 on a surface according to an example. In an example, the electronic device 400 is similar to the electronic device 200 shown and described with respect to FIG. 2A. However, the electronic device 400 may be any type of electronic device that uses or has an enclosure or a housing such as described herein.

In an example, the enclosure 410 is formed using one or more of the various processes described herein. For example, the pattern 420 is created using materials having different physical properties. In addition to the pattern 420, a computer-readable code 430, such as a QR code, is provided on a surface of the enclosure 410. Although a QR code is specifically mentioned, the computer-readable code 430 can be a serial number, a bar code, or other similar identifier.

In an example, the computer-readable code 430 is used to verify the authenticity of the electronic device 400. For example, when the pattern 420 is created, an image is taken and/or received by a computing device and/or a verification system. Various features of the pattern are identified or extracted and used to calculate a verification template that is associated with, or corresponds to, the pattern 420. The image, the features of the pattern 420, and/or the verification template are stored by the verification system.

In an example, the verification template is based on a distance between a first point 440 in the pattern 420 and a second point 450 in the pattern 420. In another example, the verification template is based on a shape or angle of an edge of the first point 440 in the pattern 420 and/or the second point 450 in the pattern 420. In yet another example, different points or features in the pattern 420 are identified and are represented by a string of numbers (e.g., 1's and 0's). In an example, the verification template acts as a “digital fingerprint” for the electronic device 400. Although two points are shown and described, the verification template may be based on a number of different points in the pattern 420.

When the verification template has been calculated, the verification template may also be encrypted and/or digitally signed. For example, the string of 1's and 0's is digitally signed and/or encrypted. The encrypted template may then be included as part of the computer-readable code 430. In an example, any type of cryptography or encryption may be used.

To authenticate the electronic device, the computer-readable code is read or scanned (e.g., by a mobile phone or other computing device). The verification template that was calculated is provided to the verification system and compared against information stored in the database. For example, the verification compares the features extracted from the enclosure (or the computer-readable code 430) and compares the features with the original template (e.g., the template that was generated when the enclosure 410 was initially formed) and generates a matching score. If the score is above a threshold or the verification templates match, the electronic device 400 is authentic.

To authenticate the electronic device, the computer-readable code is read or scanned (e.g., by a mobile phone or other computing device). The verification template that is calculated is compared to the digitally signed template that is disposed on the electronic device. If the electronic signature verifies and the template matches the electronic device 400 is authentic.

In another example, the pattern 420, or portions of the pattern 420, is captured (e.g., by a camera) and compared against an image of the pattern 420 that was taken when the enclosure 410 is formed. If the patterns match, the electronic device is authentic.

Other forms of verification and authentication are also contemplated. For example, images of the pattern 420 can be stored in a database that is only accessible to the vendor. In another example, images of the pattern 420 are stored in a database where a customer can directly look up images of devices. In yet another example, the verification template can be calculated and stored in a vendor database, the verification template can be calculated and published online. In yet another example, an algorithm for verification template calculation can be made available so that the customer can take an image, calculate the verification template, and verify the authenticity off-line. In other examples, the verification template can be calculated at a time of purchase and the verification template is provided to a database for verification. In still another example, two or more verification templates are generated and one is kept secret while another is provided to the consumer. This would allow the customer to do a quick check, but still would not allow a counterfeiter to create devices that match the secret part of the template.

In other examples, each pattern 420 is sensed after manufacturing and then stored in a database, in which the entry for the associated electronic device 400 is associated with a serial number of the electronic device 400. In another example, to verify the authenticity of the electronic device 400, a customer re-measures features of the pattern 420 and compares it to properties stored in a database. If a serial number is associated with the features, the lookup can be performed by serial number. In another example, the random properties/features of the pattern 420 are measured after manufacturing, and a set of features is extracted. Based on the pattern of these features, a numerical representation of the features is calculated. The verification template is then digitally signed by and applied to the device together with its digital signature. This is done in such a way that the template itself is not changed.

To verify the authenticity of the electronic device 400, the random properties are measured, and the verification template is calculated using the same or a similar algorithm: if the template matches the stored template and the signature verifies the device is authentic with high probability. In yet another example, patters and/or templates of known counterfeit devices can also be stored in a database for quick identification.

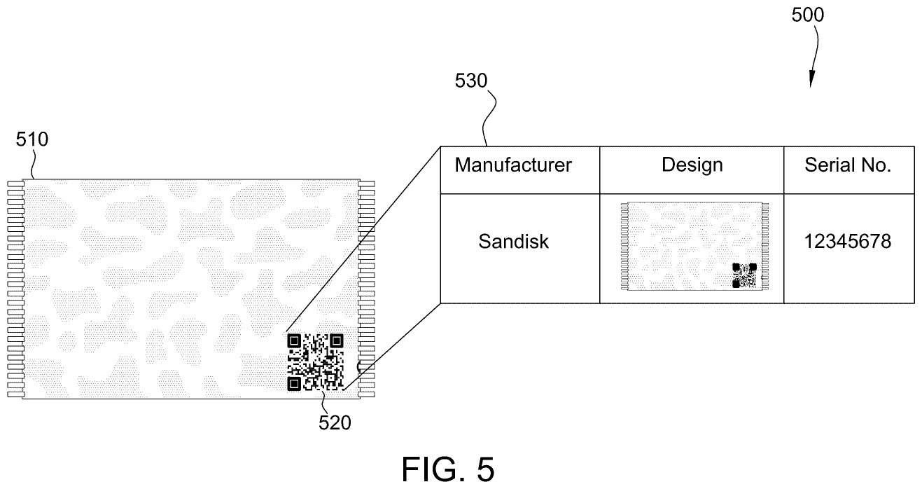

FIG. 5 illustrates an example verification database 500 that is used to authenticate an electronic device 510 according to an example. In an example, the verification database 500 is part of a verification system and is accessed when the computer-readable code 520 is read or scanned (e.g., by a computing device). When the computer-readable code 520 is read, the verification system compares information associated with the computer-readable code 520 to stored information. The verification system also returns information 530 associated with the electronic device 510 to assist a consumer in verifying the authenticity of the electronic device 510.

In an example, the information 530 includes, but is not limited to, the manufacturer of the electronic device 510, an image of the design associated with the enclosure of the electronic device 510 and a serial number (or other identifier) of the electronic device 510. Using this information a user may easily verify whether the electronic device 510 is authentic or genuine.

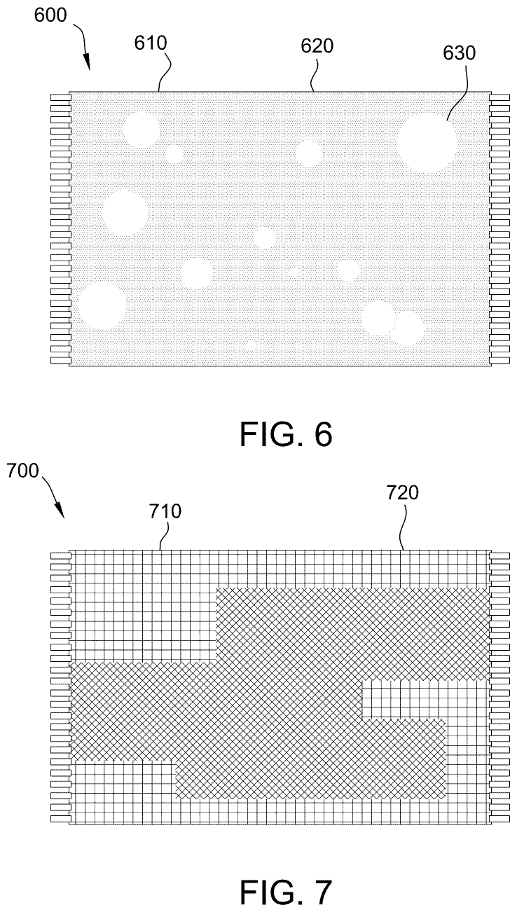

FIG. 6 illustrates an electronic device 600 having an enclosure 610 with an embedded pattern 620 according to another example. In this example, when the enclosure 610 is formed, one or more air bubbles 630 are injected or otherwise provide within the enclosure 610. For example, during a molding process, one or more air bubbles 630 are randomly injected into a first material (e.g., a molding compound) thereby resulting in a randomly-generated air bubble pattern 620 on the enclosure 610.

Although FIG. 6 illustrates the air bubbles being inserted into a first material during formation of the enclosure 610, the enclosure 610 can include multiple different materials. In such examples, air bubbles 630 may be present in both the first material and the second material. The pattern 620 is usable to verify the authenticity of the electronic device such as described herein.

FIG. 7 illustrates an electronic device 700 having an enclosure 710 with an embedded pattern 720 according to yet another example. In this example, the embedded pattern 720 is a surface texture. In an example, the surface texture is created by randomly injecting various materials into and/or on the molding compound during a molding process to create a rough exterior texture. As with other examples described herein, the pattern is usable to verify the authenticity of the electronic device 700 such as previously described.

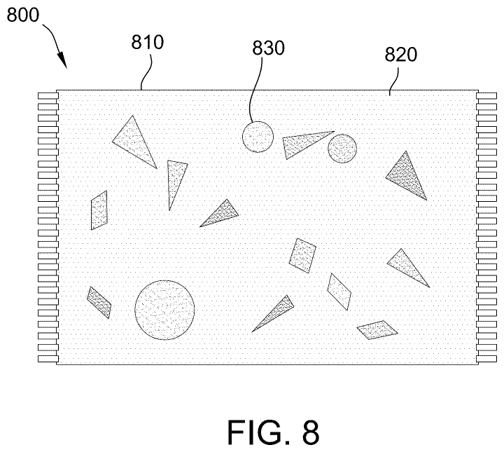

FIG. 8 illustrates an electronic device 800 having an enclosure 810 with an embedded pattern 820 according to yet another example. In this example, the enclosure 810 is comprised of a first material (e.g., a molding compound) having a particular physical property. The pattern 820 is formed by injecting various particulates 830 into the first material when the enclosure 810 is being formed (e.g., during a molding process). In an example, the particulates 830 have different colors, shapes, sizes, atomic weights and so on. As with other examples described herein, the pattern 820 is usable to verify the authenticity of the electronic device 800 such as previously described.

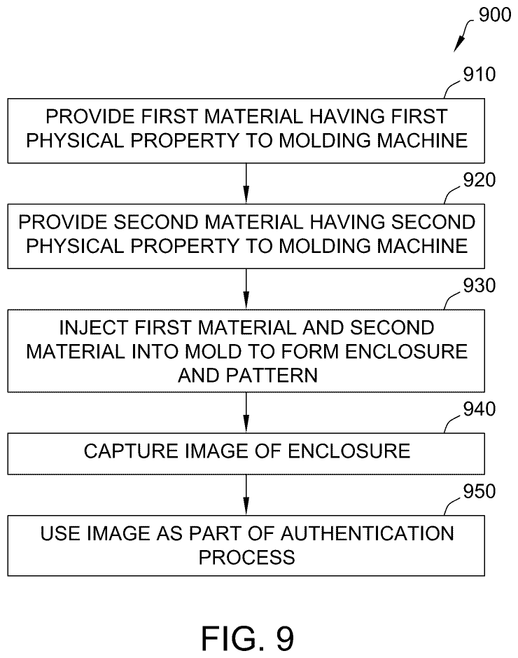

FIG. 9 illustrates a method 900 for forming an enclosure with an embedded pattern for an electronic device according to an example. In an example, the method 900, or portions of the method 900, is/are executed by a computing device associated with a molding machine (e.g., an injection molding machine, a transfer molding machine or any machine that is used to form a housing or an enclosure for an electronic device) and/or the molding machine itself. Additionally, the method 900 is used to form any of the various enclosures and associated patterns shown and described herein. For example, the method 900 is used to form the enclosure 210 shown and described with respect to FIG. 2A.

In an example, the method 900 begins when a first material having a first physical property is provided (910) to a molding machine. In an example, the first material is an epoxy resin and the first physical property is a color. Although specific materials and physical properties are mentioned, the first material may be any type of material and the first physical property may be any of the various properties previously described.

In addition to providing the first material to the molding machine, a second material having a second physical property is also provided (920) to the molding machine. In an example, the second material is the same material as, or is similar to, the first material. In another example, the second material is different from the first material. Regardless of whether the second material is the same or different from the first material, in an example, the second material has a second physical property that is different from the first physical property.

The first material and the second material are injected (930) into a mold to form the enclosure and the embedded pattern. In an example, the first material and the second material are injected into the mold at the same time. In another example, the first material is injected into the mold at a first time and the second material is injected into the mold at a second time. The first time and the second time may overlap. In another example, the first time is separate from the second time. Additionally, a time frame associated with the first time and the second time are different. In another example, the time frames are similar or are the same.

When the enclosure has formed and the pattern has been created, an image of the enclosure is captured (940). In an example, the image is used to determine one or more verification features of the electronic device such as previously described. In an example, the captured image is also used to generate a computer-readable code that is subsequently provided on a surface of the enclosure.

In an example, the captured image and/or the computer-readable code, are used to as part of an authentication process (950) to verify the authenticity of the electronic device such as previously described.

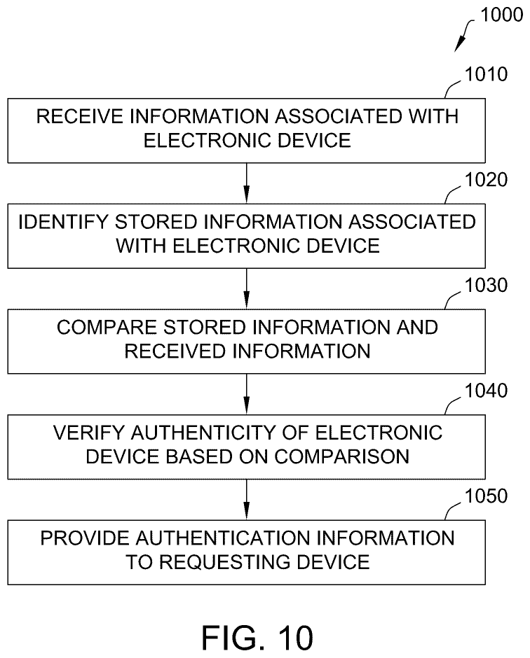

FIG. 10 illustrates a method 1000 for verifying the authenticity of an electronic device based, at least in part, on a pattern embedded within the enclosure of the electronic device according to an example. In an example, the method 1000 is executed by a verification system and is used to verify the authenticity of the electronic device 200 shown and described with respect to FIG. 2A and/or the electronic device 300 shown and described with respect to FIG. 3.

In an example, the method 1000 begins when information associated with an electronic device is received (1010). In an example, the information associated with the electronic device is provided to the verification system in the form of an image. For example, a user or a consumer may have captured an image of the electronic device and the associated pattern on the enclosure and provided the information (e.g., via a network) to the verification system. In another example, the information associated with the electronic device is information read from or otherwise associated with a computer-readable code.

When the information is received, the verification system identifies (1020) stored information associated with the electronic device. In an example, the stored information includes manufacturer information, pattern information, a serial number or other identifier and/or other information (e.g., capacity information).

When the stored information is identified, the verification system compares (1030) the received information with the stored information. Based, at least in part, on the comparison, the authentication system verifies (1040) the authenticity of the electronic device. For example, the verification system compares a received verification feature to the stored verification feature. In another example, the verification system compares the pattern of the enclosure from the received information with the pattern of the enclosure in the stored information. Although specific examples are given, the authenticity of the electronic device is verifiable in various ways and/or though various cryptographic processes.

When the authenticity of the electronic device has been determined, the verification system provides (1050) authentication information to the requesting device. In an example, the authentication information is the stored information associated with the electronic device. In another example, the authentication information is a message that indicates whether the electronic device is authentic.

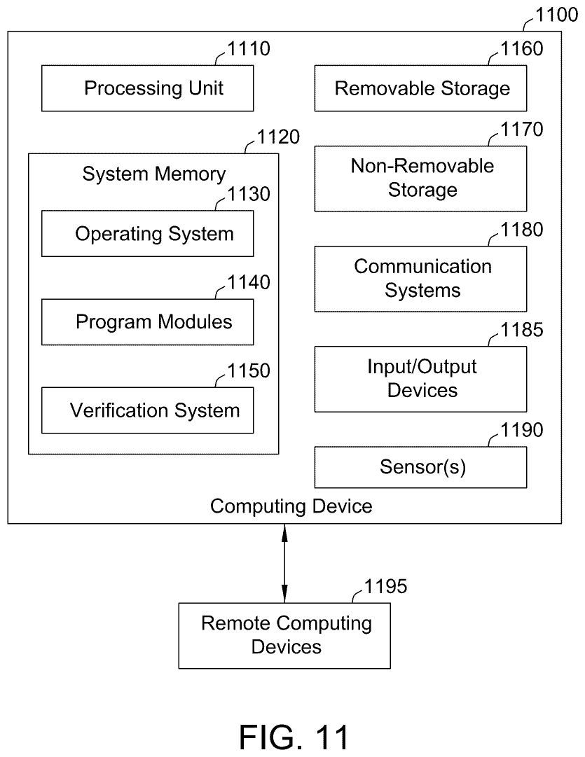

FIG. 11 is a system diagram of a computing device 1100 according to an example. The computing device 1100, or various components and systems of the computing device 1100, may be integrated or associated with a molding machine such as, for example, a molding machine that is used to form the enclosure and/or embedded pattern shown and described herein. For example, the computing device 1100 may control the timing and/or activation of one or more injectors of the molding machine that inject a first material and/or a second material into a mold such as described herein.

In another example, the computing device 1100 is part of, or includes a verification system 1150. In an example, the verification system 1150 is used to verify the authenticity of an electronic device. For example, the computing device 1100 or the verification system 1150 may receive verification information (e.g., feature information, image information) from a remote computing device 1195. When this information is received, the verification system 1150 uses the received information to verify the authenticity of the electronic device, based, at least in part, on the pattern of the enclosure, such as previously described.

In yet other examples, the computing device 1100 can execute or otherwise perform one or more operations of the various methods shown and described herein. For example, the computing device 1100, or various components or systems of the computing device 1100, may be used to capture an image of an enclosure of the electronic device and the associated pattern, generate/calculate verification features, compare received information with stored information and so on.

The computing device 1100 may include at least one processing unit 1110 and a system memory 1120. The system memory 1120 may include, but is not limited to, volatile storage (e.g., random access memory), non-volatile storage (e.g., read-only memory), flash memory, or any combination of such memories. The system memory 1120 may also include an operating system 1130 that controls the operation of the computing device 1100 and one or more program modules 1140. The program modules 1140 may be responsible for executing one or more operations of forming an enclosure. While being executed by the processing unit 1110, the program modules 1140 may perform the various processes described above.

The computing device 1100 may also have additional features or functionality. For example, the computing device 1100 may include additional data storage devices (e.g., removable and/or non-removable storage devices) such as, for example, magnetic disks, optical disks, or tape. These additional storage devices are labeled as a removable storage 1160 and a non-removable storage 1170.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 11 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 1100 on the single integrated circuit (chip). The disclosure may also be practiced using other technologies capable of performing logical operations such as, for example, AND, OR, and NOT, including but not limited to mechanical, optical, fluidic, and quantum technologies.

The computing device 1100 may include one or more communication systems 1180 that enable the computing device 1100 to communicate with one or more remote computing devices 1195 or systems. Examples of communication systems 1180 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 1100 may also have one or more input devices and/or one or more output devices shown as input/output devices 1185. These input/output devices 1185 may include a keyboard, a sound or voice input device, haptic devices, a touch, force and/or swipe input device, a display, speakers, etc. The aforementioned devices are examples and others may be used.

The computing device 1100 may also include one or more sensors 1190. The sensors may be image sensors that are used to capture one or more images of an enclosure and/or an associated pattern and/or compare a received image with a stored image.

Accordingly, examples of the present disclosure describe an enclosure for an electronic device, comprising: a first material having a first property; and a second material having a second property that is different from the first property, wherein the first material having the first property and the second material having the second property are combined during formation of the enclosure and create a random pattern for the enclosure. In an example, the random pattern is used to authenticate the electronic device. In an example, at least one of the first material and the second material is a molding compound and wherein at least one of the first property and the second property is a pigment content. In an example, the first property is a first absorption property and the second property is a second absorption property. In an example, at least one of the first and the second material contains a particulate. In an example, the enclosure also includes a computer-readable code provided on an outer surface of the enclosure. In an example, the first property is a fluorescence. In an example, the first material is injected into a mold associated with the enclosure at a first time and in a first direction and the second material is injected into the mold associated with the enclosure at a second time and in a second direction. In an example, the first time is different than the second time.

Examples also describe an enclosure for an electronic device, comprising: an embedded pattern provided on an outside surface of the enclosure, the embedded pattern: being formed during formation of the enclosure; and for verifying an authenticity of the electronic device. In an example, the embedded pattern includes a surface texture. In an example, the embedded pattern includes at least two absorption properties. In an example, the enclosure includes at least a first material and a second material. In an example, the first material is a resin and the second material contains a particulate. In an example, the enclosure also includes a computer-readable code provided on an outer surface of the enclosure.

Examples also describe an electronic device, comprising: an enclosing means surrounding at least one electronic component of the electronic device, the enclosing means comprising: an embedded random pattern, the embedded random pattern being created by combining a first material having a first property and a second material having a second property during formation of the enclosing means. In an example, the first material is a resin. In an example, the first property is at least one of: a pigment content; a dye content; an absorption property; and a density. In an example, the enclosing means includes a computer-readable identification means provided on a surface of the enclosing means. In an example, the second material includes a particulate.

The description and illustration of one or more aspects provided in the present disclosure are not intended to limit or restrict the scope of the disclosure in any way. The aspects, examples, and details provided in this disclosure are considered sufficient to convey possession and enable others to make and use the best mode of claimed disclosure.

The claimed disclosure should not be construed as being limited to any aspect, example, or detail provided in this disclosure. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

References to an element herein using a designation such as “first,” “second,” and so forth does not generally limit the quantity or order of those elements. Rather, these designations may be used as a method of distinguishing between two or more elements or instances of an element. Thus, reference to first and second elements does not mean that only two elements may be used or that the first element precedes the second element. Additionally, unless otherwise stated, a set of elements may include one or more elements.

Terminology in the form of “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As an additional example, “at least one of: A, B, or C” is intended to cover A, B, C, A-B, A-C, B-C, and A-B-C, as well as multiples of the same members. Likewise, “at least one of: A, B, and C” is intended to cover A, B, C, A-B, A-C, B-C, and A-B-C, as well as multiples of the same members.

Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

What is claimed is:

1. An enclosure for an electronic device, comprising:
a first material having a first property; and
a second material having a second property that is different from the first property, wherein the first material having the first property and the second material having the second property are combined during formation of the enclosure and create a random pattern for the enclosure.

2. The enclosure of claim 1, wherein the random pattern is used to authenticate the electronic device.

3. The enclosure of claim 1, wherein at least one of the first material and the second material is a molding compound and wherein at least one of the first property and the second property is a pigment content.

4. The enclosure of claim 1, wherein the first property is a first absorption property and the second property is a second absorption property.

5. The enclosure of claim 1, wherein at least one of the first and the second material contains a particulate.

6. The enclosure of claim 1, further comprising a computer-readable code provided on an outer surface of the enclosure.

7. The enclosure of claim 1, wherein the first property is a fluorescence.

8. The enclosure of claim 1, wherein the first material is injected into a mold associated with the enclosure at a first time and in a first direction and the second material is injected into the mold associated with the enclosure at a second time and in a second direction.

9. The enclosure of claim 8, wherein the first time is different than the second time.

10. An enclosure for an electronic device, comprising:
an embedded pattern provided on an outside surface of the enclosure, the embedded pattern:
being formed during formation of the enclosure; and
for verifying an authenticity of the electronic device.

11. The enclosure of claim 10, wherein the embedded pattern includes a surface texture.

12. The enclosure of claim 10, wherein the embedded pattern includes at least two absorption properties.

13. The enclosure of claim 10, wherein the enclosure includes at least a first material and a second material.

14. The enclosure of claim 13, wherein the first material is a resin and the second material contains a particulate.

15. The enclosure of claim 10, further comprising a computer-readable code provided on an outer surface of the enclosure.

16. An electronic device, comprising:
an enclosing means surrounding at least one electronic component of the electronic device, the enclosing means comprising:
an embedded random pattern, the embedded random pattern being created by combining a first material having a first property and a second material having a second property during formation of the enclosing means.

17. The electronic device of claim 16, wherein the first material is a resin.

18. The electronic device of claim 17, wherein the first property is at least one of:
a pigment content;
a dye content;
an absorption property; and
a density.

19. The electronic device of claim 16, further comprising a computer-readable identification means provided on a surface of the enclosing means.

20. The electronic device of claim 16, wherein the second material includes a particulate.
